(19) United States
(12) Patent Application Publication
(10) Pub. No.: US 2022/0065383 A1
(43) Pub. Date: Mar. 3, 2022

(54) INSULATED HOSE ARRANGEMENTS

(71) Applicant: Swagelok Company, Solon, OH (US)

(72) Inventors: Daniel Gutmann, Aurora, OH (US); Stephen J. Zaborszki, Northfield Center, OH (US); Corey Pasheilich, Solon, OH (US); Tony Galang, Cleveland, OH (US); Josh Manis, Valley View, OH (US)

(21) Appl. No.: 17/460,516

(22) Filed: Aug. 30, 2021

Related U.S. Application Data
(60) Provisional application No. 63/072,439, filed on Aug. 31, 2020.

(51) Int. Cl. F16L 59/02

(52) U.S. Cl. CPC F16L 59/027; F16L 11/15

(57) ABSTRACT

A hose assembly includes a flexible hose, an end connection attached to a first end of the hose, an insulation material wrapped onto the exterior surface of the hose, a cover surrounding the insulation material, and a cuff extending over and in engagement with at least a portion of the end connection and the cover. The insulation material, the cover, and the cuff each include fire resistant materials rated for continuous use at a temperature of at least about 90° C.

### CROSS-REFERENCE TO RELATED APPLICATION

This application claims priority to and all benefit of U.S. Provisional Patent Application Ser. No. 63/072,439, filed on Aug. 31, 2020, for INSULATED HOSE ARRANGEMENTS, the entire disclosure of which is fully incorporated herein by reference.

### TECHNICAL FIELD

The present disclosure relates to flexible hose assemblies and to methods of making flexible hose assemblies. More particularly, the disclosure relates to flexible hoses having thermal insulation configured to maintain hose flexibility while providing for extreme operating temperatures (e.g., temperatures as low as −53° C. or lower and/or as high as 250° C. or higher).

### SUMMARY OF THE DISCLOSURE

In accordance with an embodiment of one or more of the inventions presented in this disclosure, an exemplary hose assembly includes a flexible hose, an end connection attached to a first end of the hose, an insulation material wrapped onto the exterior surface of the hose, a cover surrounding the insulation material, and a cuff extending over and in engagement with at least a portion of the end connection and the cover.

In accordance with another embodiment of one or more of the inventions presented in this disclosure, a method of making a hose assembly is contemplated. In an exemplary method, a hose is provided, defining an internal fluid passage and an exterior surface, and having an end connection attached to a first end of the hose. An insulation material is wrapped onto the exterior surface of the hose. A cover is installed around the insulation material. A cuff is installed over and in engagement with at least a portion of the end connection and the cover.

### BRIEF DESCRIPTION OF THE DRAWINGS

Further advantages and benefits will become apparent to those skilled in the art after considering the following description and appended claims in conjunction with the accompanying drawings, in which:

FIG. 1 is a partial cross-sectional view of an insulated hose assembly, in accordance with another exemplary embodiment of the present disclosure;

FIG. 2 is a partial cross-sectional view of another insulated hose assembly, in accordance with another exemplary embodiment of the present disclosure;

FIG. 2A illustrates a stacked insulation strip arrangement for wrapping onto a hose, in accordance with another exemplary embodiment of the present disclosure;

FIG. 2B illustrates an end view of the stacked insulation strip arrangement of FIG. 2A, shown wrapped onto a hose;

FIG. 2C illustrates a stacked insulation strip arrangement for wrapping onto a hose, in accordance with another exemplary embodiment of the present disclosure;

FIG. 2D illustrates an end view of the stacked insulation strip arrangement of FIG. 2C, shown wrapped onto a hose;

FIG. 3 is a partial cross-sectional view of another insulated hose assembly, in accordance with another exemplary embodiment of the present disclosure;

FIG. 3A illustrates a stacked insulation strip and plastic cover arrangement for wrapping onto a hose, in accordance with another exemplary embodiment of the present disclosure;

FIG. 3B illustrates an end view of the stacked insulation strip and plastic cover arrangement of FIG. 3A, shown wrapped onto a hose;

FIG. 3C a stacked insulation strip and plastic cover arrangement for wrapping onto a hose, in accordance with another exemplary embodiment of the present disclosure; and

FIG. 3D illustrates an end view of the stacked insulation strip and plastic cover arrangement of FIG. 3C, shown wrapped onto a hose.

### DESCRIPTION OF THE EXEMPLARY EMBODIMENTS

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Many applications have requirements for flexible hose to provide a fluid connection between two points in a fluid system, with the flexibility of the hose allowing for various fluid line routing requirements, thermal expansion, misalignment, and intermittent or continuous flexing (e.g., due to system vibrations). Some flexible hoses may be provided with a core tube material (e.g., stainless steel) selected for suitability for use with extreme high or low system temperatures that have relatively high thermal conductivity. Such hoses may require insulation surrounding the core tube, for example, to provide stability of temperature control, to avoid condensation in low temperature applications, and/or to protect users from burns in high temperature applications. Known insulated hose assemblies use fiberglass-based or “black foam” insulation encased around the hose, which often result in a significant increase in the outer diameter of the insulated hose assembly, and/or reduced flexibility of the hose assembly. Many insulation materials are prone to generating excessive dust or other contaminants, which are particularly undesirable in some hose applications.

In another embodiment, a hose may be provided with a spiral-wrapped insulation material, such as, for example an aerogel composite insulation material (e.g., a tape, strip, or sheet) may be wrapped around an outer surface of a hose to provide exterior insulation for the hose. The aerogel composite may include a variety of suitable materials, including for example, an expanded PTFE (ePTFE) and aerogel mixture formed, for example, by extrusion or two-roll processing. Exemplary hoses with spiral-wrapped insulation are described in co-owned U.S. patent application Ser. No. 16/810,900 filed on Mar. 6, 2020 and entitled INSULATED HOSE ARRANGEMENTS (the “'900 application”), the entire disclosure of which is incorporated herein by reference.

According to an exemplary aspect of the present application, other insulation sheet materials may provide beneficial properties, such as, for example, high temperature ratings, effective thermal insulation, flame resistance, minimal particle generation, and ease of handling (e.g., reduced stickiness). As one example, a carbon fiber based material, for example, as commonly used in welding blankets, may provide suitable insulation values (e.g., thermal conductivity up to about 33 mW/m K at room temperature (23° C.), similar to some aerogel composites) and higher usage temperatures (e.g., up to about 250° C. or greater), minimal dust/particle generation (adequate for a “non-harmful” classification), and suitable flammability ratings (e.g., passing UL94 v0 flammability testing). An exemplary carbon fiber based insulating sheet material is an Oxidized Fiber Felt (OFF) insulation, such as, for example, Zoltek OX Oxidized PAN Fiber Felt, part number FT0575-095.

Some insulation sheet materials, such as, for example, carbon fiber felt materials, are not well suited for spiral wrapping on a hose, for example, due to a lack of tackiness of the material (resulting in slippage of the material during wrapping), and/or high compressibility of the material (e.g., compression to half the material thickness, or thinner) causing a reduction in the insulation value of the material. According to an exemplary aspect of the present disclosure, an insulation sheet material may be provided in longitudinally extend strips of material, wrapped lengthwise around the hose, with minimal overlap of the longitudinal ends of the insulation strips. Multiple strips of insulation material may be wrapped concentrically around the hose to provide multiple layers of insulation as needed. Other wrapped arrangements (e.g., spiral wrapped) may additionally or alternatively be used.

The insulation sheet material may be provided in a variety of thicknesses, including, for example, between approximately 0.08 inches and 0.50 inches thick (e.g., ¼ inch nominal thickness, ½ inch nominal thickness), and may be cut to a variety of suitable widths, including, for example, approximately 5.5 inches wide to accommodate a % inch diameter hose, with an overlapping seam width of less than about ½ inch, or about ⅜ inch. In embodiments utilizing multiple layers of insulation sheet material, the width of the outer layer strips of material may be increased to accommodate the larger circumference of the outer layers, and/or to minimize compression of the inner layers.

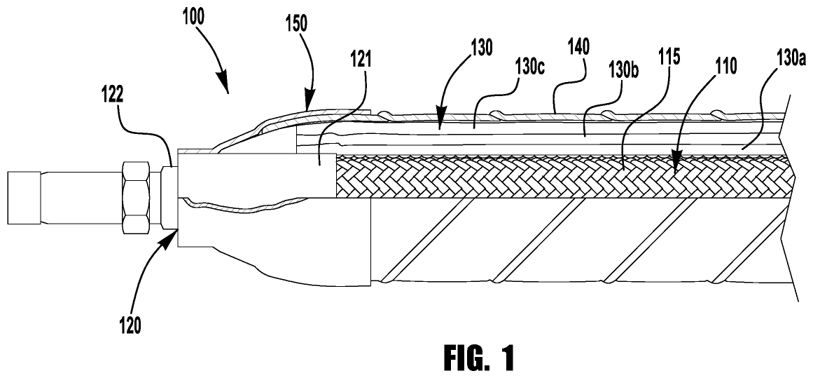

FIG. 1 illustrates an exemplary insulated hose assembly 100 including a hose 110 (e.g., a metal hose including a corrugated core tube, not shown, and braided metal sheath 115) extending to a metal end connection 120 (e.g., tube stub end connection for welding or connection with a tube fitting) crimped, welded, or otherwise attached to the hose 110 and an insulation material 130 surrounding the hose. While only one end of the hose assembly 100 is shown, an opposite end of the hose assembly may (but need not) include a similar end connection arrangement.

One or more strips 130a, 130b, 130c of insulation sheet material (e.g., having one or more of the properties described above) are wrapped lengthwise over the braided metal sheath 115 to provide one or more substantially uniform layers of insulation material 130 along the length of the hose 100. The insulation material strips 130a, 130b, 130c may be installed on the hose 100 using a variety of arrangements. For example, the insulation material strips may be wrapped around the hose and secured in place, once wrapped onto the hose, by one or more sutures, stitches, adhesives, and/or fasteners (e.g., hook and loop fasteners). As another example, the longitudinal ends of the insulation material strip(s) may be joined (e.g., using one or more sutures, stitches, adhesives, and/or fasteners) to form an insulating sleeve that may then be socked or slid onto the hose.

According to another aspect of the present disclosure, the insulated hose may be provided with a cover similarly selected for extreme temperature ratings (e.g., at least about 250° C. or up to about 260° C. continuous use, or intermittent brief temperatures up to about 1200° C.), for example, for use in environments at these temperatures), waterproofing, vapor permeability, and flame resistance. While many different cover materials may be utilized, in an exemplary embodiment, a durable, thermally resistant engineered fabric may be used as a cover wrap for the hose. In the exemplary embodiment of FIG. 1, a strip of covering fabric 140 (e.g., having one or more of the properties described above) is spiral wrapped onto the insulation material 130, in a partially overlapping arrangement (approximately 50% overlap), to a tension sufficient to secure the wrapped fabric cover in place (even in the absence of an adhesive bond), while maintaining high flexibility and low bending force of the wrapped hose.

The fabric may be provided in an elongated strip having a suitable width (e.g., between about 1 inch and about 5 inches, or about 3 inches), spiral wrapped over the insulation material. Exemplary materials include aramid fiber fabrics, such as Kevlar®, or ePTFE-based engineered fabrics, such as Gore-Tex®. The engineered fabric may be sufficiently stretchable to maintain bendability/flexibility of the wrapped hose and may be wrapped on the insulation material without adhesively bonding the fabric cover to the insulation material to further maintain bendability/flexibility of the wrapped hose. In one such embodiment, the engineered fabric may include a matrix oriented to minimize stretchability along the length of the fabric strip (e.g., less than about 1% elongation at 5 lbs tensile force) while provide more substantial stretchability across the width of the strip (e.g., at least about 10% elongation at 5 lbs tensile force). This arrangement provides tension (e.g., about 5 lbs tensile force) to secure the wrapped fabric cover in place (even in the absence of an adhesive bond), while maintaining high flexibility and low bending force of the wrapped hose. In an exemplary embodiment, an engineered fabric cover wrap is formed from fire retardant PTFE/polyester fabric having a density of approximately 5 oz per square yard and an operating temperature range of −200° C. to 180° C., provided in an approximately 3 inch wide strip and tightly spiral wrapped around an insulation wrapped hose in an overlapped fashion (e.g., approximately 50% overlap).

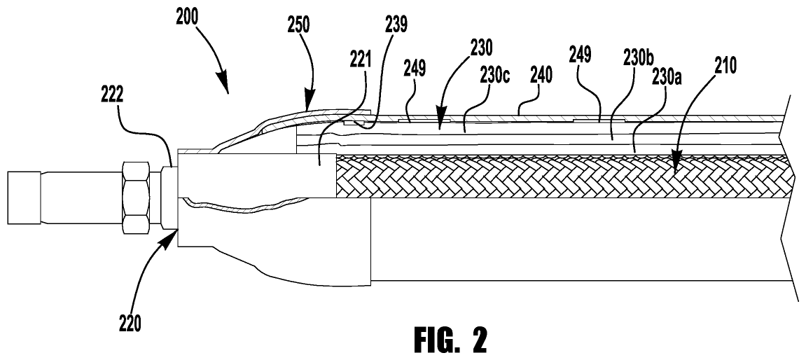

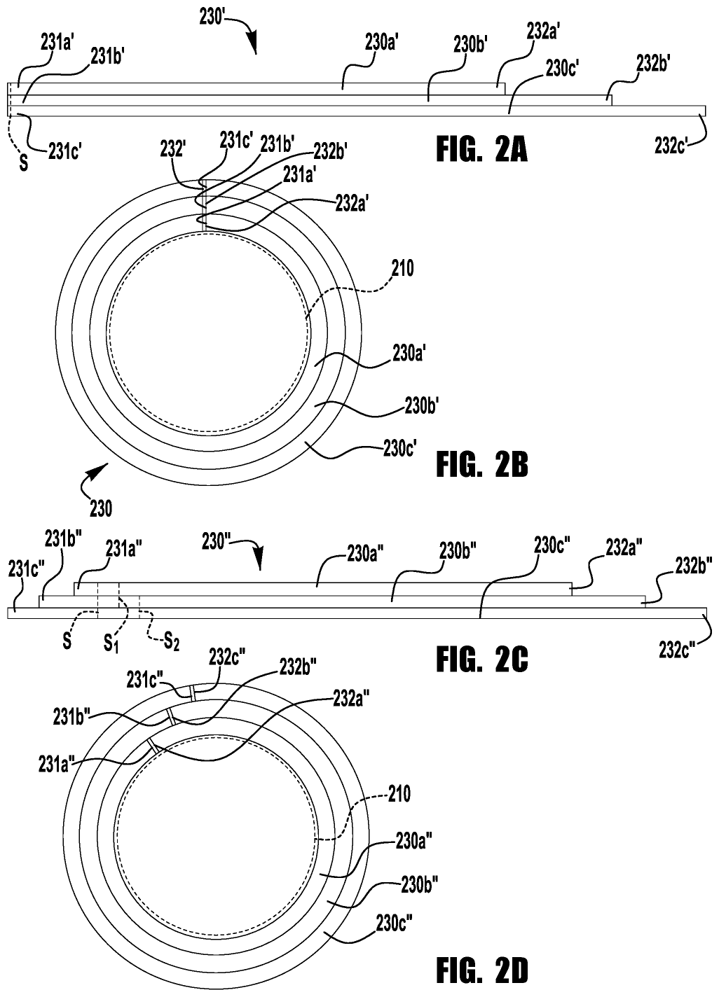

In another exemplary embodiment, a polymeric tube or sleeve cover may be applied or installed over the insulation layer, for example, in a material selected to provide a flame retardant cover and/or to prevent vapor permeability of the insulated hose assembly. FIG. 2 illustrates an exemplary hose assembly 200 with longitudinally wrapped insulation material 230 (shown as strips 230a, 230b, 230c forming three layers of insulation, but different numbers of strips/layers may be used) surrounding the hose 210, similar to the hose assembly 100 of FIG. 1, with a tube or sleeve cover 240 closely fitting over the insulation material. In one such example, a polyolefin tube having a thickness of about 1 mm and an operating temperature range of −55° C. to about 135° C. may be installed over the insulation layer and heat shrunk into retention against the insulation layer. In an exemplary arrangement, an insulation wrapped hose is inserted through a polyolefin tube (with air plumbed into the tube to inflate the tube, if needed). The tube is heated (e.g., by a heat gun and/or oven) to temperatures up to about 177° C. to shrink the tube material into compressive engagement with the insulation layer. Ends of the heat shrunk tube may be trimmed as needed.

In another exemplary embodiment, a polymer-coated fiberglass sleeve (e.g., “fire jacket” or “fire sleeve”) may be slid over the insulation layer on the hose to function as a flexible, touch safe cover for the insulated hose. Such materials may be rated for flame retardancy standards, may provide additional insulation value, and/or may resist melting/degradation at high temperatures (e.g., up to at least 200° C.). One such exemplary sleeve is a Pyrotex Aerospace-grade Braid Firesleeve compounded silicone rubber coated fiberglass sleeve, manufactured by Atlantex Mfg Co. In one such exemplary arrangement, the sleeve is generally close fitting around the insulation but is not heat shrunk onto the hose.

As shown in the embodiments of FIGS. 1 and 2, the insulation material 130, 230 and cover 140, 240 may (but need not) extend over a rearmost portion or collar 121, 221 of the metal end connection 120, 220. While the metal connections are usually rated to withstand extreme temperatures, user handling of the thermally conductive end connections may be hazardous when the hose is exposed to extreme temperatures. Additionally, some covers (e.g., fabric wrapped or non-heat shrunk sleeve covers) may tend to spread apart from the hose ends, thereby limiting insulation at the ends. According to another aspect of the present disclosure, a thermal resistant cuff may be provided over a metal end connection of a hose, extending over an end portion of the insulation material and cover of the hose assembly.

In the exemplary embodiments of FIGS. 1 and 2, a thermally resistant cuff 150, 250 is installed over a base portion 122, 222 of the end connection and extends rearward over the end portions of the insulation material 130, 230 and cover 140, 240. The cuff may be provided in a material having a continuous use temperature comparable to that of the insulation material (e.g., at least about 250° C., or about 260° C.), such as, for example, silicone.

While a hose cuff may be provided in heat shrunk material to reliably grip the hose or hose end, an exemplary thermally resistant cuff may be provided in an elastomeric material selected to permit elastic stretching or expansion of the cuff for alignment of the cuff with the hose end (e.g., adjacent portions of the end connection and cover), and subsequent contraction into gripping or compressive retained engagement on the hose end. In an exemplary embodiment, a silicone cuff has a durometer of between about 20 and about 50, or between about 35 and about 45, or about 40, to permit elastic stretched installation of the cuff. Further, the silicone cuff may be peroxide cured (e.g., black high temperature peroxide cured silicone tubing, capable of meeting UL94 VO flammability ratings) to minimize drying or cracking of the cuff due to prolonged exposure to high temperatures.

In an exemplary method of fabricating the insulated hose 200 of FIG. 2, strips of insulating material may be secured (e.g., sewed) together along longitudinal ends to form a multi-layer tube of insulating material. The exemplary tube of insulating material may be slid or socked over the hose 210. Alternatively, as shown in FIGS. 2A and 2B, the strips 230a′, 230b′, 230c′ of insulating material 230′ may be secured together (as s, as shown) along only one longitudinal end 231a′, 231b′, 231c′ and then wrapped around the hose 210′, with the free ends 232a′, 232b′, 232c′ of the strips aligning with (e.g., abutting or overlapping) the sewed ends. To provide a substantially uniform outer surface of the insulated hose 200′ and/or to minimize compression of the inner layers, the widths of the insulating material strips 230a′, 230b′, 230c′ may be stepped or incremented to compensate for the varied circumference at the corresponding diameter of each strip, such that the free ends 232a′, 232b′, 232c′ of the strips more closely align with (e.g., abutting or minimally overlapping) the circumferential position of the sewed ends 231a′, 231b′, 231c′ (e.g., abutting or minimally overlapping) of the strips.

In other embodiments, a stack of insulating material layers may be staggered, for example, to eliminate or avoid a circumferentially aligned or “clocked” seam of each layer, for example, to eliminate a potential hot spot at this circumferential location of the hose. As shown in FIGS. 2C and 2D, the strips 230a″, 230b″, 230c″ of insulating material 230″ may be stacked and secured together (e.g., sewed together) such that both the first longitudinal ends 231a″, 231b″, 231c″ and the second longitudinal ends 232a″, 232b″, 232c″ are stepped, staggered, or incremented, such that when the insulation strips are wrapped around the hose 210″, the seams of each insulation layer are incrementally spaced around the circumference of the hose. The first longitudinal ends 231a″, 231b″, 231c″ of the strips 230a″, 230b″, 230c″ may be incrementally staggered by a uniform distance (e.g., about ¼ inch to about 1 inch, or about 0.4 inches), for example, to sufficiently displace the seams of each insulation layer from each other to avoid a gap or seam across the insulation. The second longitudinal ends 232a″, 232b″, 232c″ may be incrementally staggered by an amount adequate to compensate for the varied circumference at the corresponding diameter of each strip, such that the second longitudinal ends more closely align with (e.g., abutting or minimally overlapping) the circumferential position of the first longitudinal ends 231a″, 231b″, 231c″ (e.g., abutting or minimally overlapping) of the strips. In securing the strips 230a″, 230b″, 230c″ of insulating material 230″ together, all of the strips may be secured together at a single location s, or at spaced apart locations s₁ (joining first and second strips 230a″, 230b″), s₂ (joining second and third strips 230b″, 230c″), for example, to minimize the compression of the insulation layers at a single circumferential location.

Referring back to FIG. 2, the insulating material 230 is held in place, for example, using one or more bands 239 (e.g., stainless steel tie bands) secured around end portions of the insulation material. The cover 240 is slid or socked over the insulating material 230 and may be secured in place on the insulating material, for example, using one or more strips of silicone self-fusing tape 249. Elastomeric cuffs 250 are then stretched over the end connections 220, covering the bands 239, the cut end of the cover 240, and a proximal end portion of the end connection 220.

In another embodiment, a cover for an insulated hose may include a suitable plastic material selected to provide a flame retardant, high temperature rated covering. The plastic cover may be provided as a tubular sleeve closely fitting over the hose insulation material. In one such embodiment, a plastic sheet material may be longitudinally wrapped around the insulated hose and welded together (e.g., along the longitudinal ends) to form a seamless tube closely fitting around the hose insulation material. While many different plastic materials may be used, in an exemplary embodiment, the plastic sheet cover may be formed from a flame retardant vinyl (e.g., material used in truck tarps) rated for continuous high temperature use (e.g., about 90° C. or temperatures up to about 93° C.).

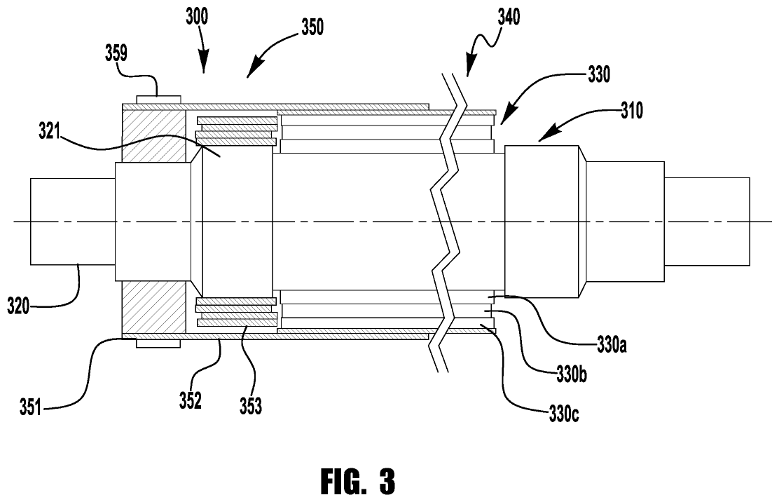

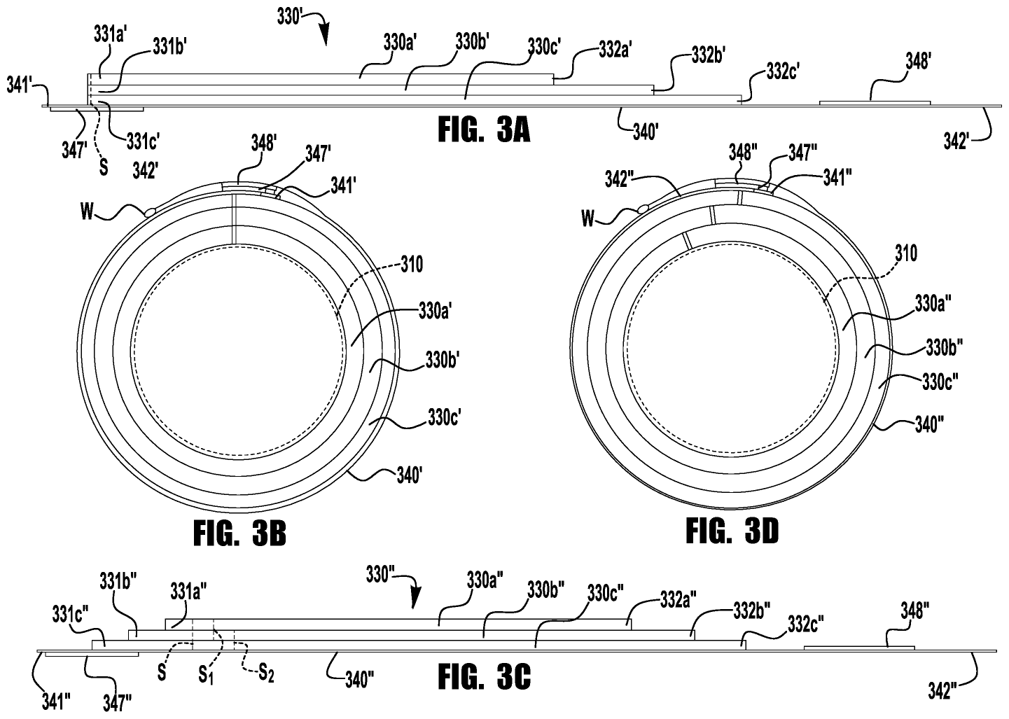

FIG. 3 illustrates a cross-sectional view of an exemplary hose assembly 300 with longitudinally wrapped insulation material 330 (shown as strips 330a, 330b, 330c forming three layers of insulation, but different numbers of strips/layers may be used), similar to the hose assemblies 100, 200 of FIGS. 1 and 2, with a tubular plastic cover 340 closely fitting over the insulation material. In an exemplary embodiment, the tubular cover 340 is formed from a flame retardant vinyl strip wrapped longitudinally around the hose, with an overlapping portion of the wrapped vinyl material (½ inch to ⅝ inch) welded together to form a seamless tubular cover without leak points along the length of the cover. The vinyl sheet may be welded into a tubular sleeve prior to socked/sliding installation on the hose, or may be wrapped around the hose and then welded in this hose wrapping condition.

As shown in FIGS. 3A-3D, a stack 330′, 330″ of insulating material strips 330a′-c′, 330a″-c″ (here shown with three layers of insulation, although different numbers of layers may be used), for example, similar to the stacked insulation layer arrangements 230′, 230″ of FIGS. 2A-2D, may be secured with a vinyl strip cover sheet 340′, 340″ for example, for desired staggered arrangement of the insulating strips and vinyl cover, as described above.

The stack of insulating material 330′, 330″ and cover sheet material 340′, 340″ are wrapped lengthwise around the hose 310′ (FIGS. 3B and 3D), with the free ends 332a′-c′, 332a″-c″ of the insulation strips 330a′-c′, 330a″-c″ overlapping the sewed ends 331a′-c′, 331a″-c″, and with the free end 342′, 342″ of the vinyl cover extending past the insulation material and onto the secured end 341′, 341″ of the wrapped vinyl cover. The stack of insulating material 330′, 330″ and cover sheet material 340′, 340″ may be held in this wrapped condition, for example, using hook-and-loop (e.g., Velcro®) fastener strips, which may, for example, be a flame retardant material. In the illustrated examples, a first hook-and-loop fastener strip 347′, 347″ is secured to the outer surface of the cover sheet 340′, 340″ at the first end 341′, 341″, and a mating second hook-and-loop fastener strip 348′, 348″ is secured to the inner surface of the second longitudinal end 342′, 342″ of the cover sheet. In another embodiment (not shown), a first hook-and-loop fastener strip may be secured to the inner surface of the cover sheet at the first, secured end, and a mating second hook-and-loop fastener strip may be secured to the outer surface of the cover sheet at the second, free end. In other embodiments, the first and/or second ends of the cover sheet may be provided with multiple fasteners strips and/or wider fastener strips to accommodate a variety of hose cross-sectional sizes and/or insulation thicknesses.

With the stack of insulating material 330′, 330″ and cover sheet material 340′, 340″ held in the wrapped condition, the overlapping first and second longitudinal ends 341′, 341″, 342′, 342″ of the cover sheet 340′, 340″ may then be welded together using, for example, a heat gun set at a suitable welding temperature with a suitably shaped nozzle and a roller to bond the cover material (e.g., flame retardant vinyl) together.

Tubular plastic covers for insulated hose assemblies, like the exemplary embodiments of FIGS. 3-3D, may utilize a less flexible cover material, which may be less accommodating to sealing with the elastomeric cuffs 150, 250 described above. Accordingly to another exemplary aspect of the present disclosure, as shown in FIG. 3, an insulated hose 300 having a tubular cover 340 may be provided with a touch safe insulating cuff arrangement 350 having an end portion 351 affixed to the hose end connection 320 and a skirt portion 352 affixed to the end portion and extending axially over the hose end collar 321 and overlapping the cover 340, with a filler insulation 353 axially disposed between the end portion and the hose insulation material 330.

While the hose insulating cuff may be a unitary component, in the illustrated embodiment, the end portion 351 of the cuff 350 is formed from a cylindrical ring of material (e.g., an elastomer, such as silicone rubber, or other suitable material), which may be press or interference fit onto the end connection 320. In one such embodiment, the end portion may be a split ring, for example, to facilitate installation on an end connection having an enlarged end. The skirt portion 352 may, for example, be formed from a strip of plastic material (e.g., flame retardant vinyl) rolled/wrapped around the end portion and welded together along the longitudinal ends of the strip. The skirt portion 352 may be clamped onto the end portion 351, for example, using a band/clamp 359, or may be crimped into a notch/slit in the end portion. The distal end 354 of the skirt portion 352 may be slip fit over the cover 340 and not mechanically fixed to the cover, allowing the hose more freedom to bend or flex with respect to the end connection 320.

The filler insulation 353 may be formed from a variety of insulating materials, including, for example, one or more wrapped strips of oxidized fiber felt (e.g., the same material as the hose insulation material 330), and may be elastically compressed, both radially between the end connection collar 321 and the cuff skirt portion 352 and axially between the cuff end portion 351 and the hose insulation material 330, such that when the hose end is bent or flexed, the filler insulation may expand to fill the space between the cuff 350, the end connection 320, and the hose insulation 330.

In an exemplary method of fabricating the insulated hose 300 of FIG. 3, the strips 330a, 330b, 330c of insulating material 330 and the vinyl cover sheet 340 are sewed together at or near the first longitudinal ends to form a loose stack, for example, as shown in the embodiments of FIGS. 3A and 3C. The stack of insulating material 330 and cover sheet material 340 are then wrapped lengthwise around the hose 310, with the free, second longitudinal ends of the insulation strips 330a, 330b, 330c abutting or overlapping the sewed ends, and with the first and second longitudinal ends of the vinyl cover overlapping. The stack of insulating material 330 and cover sheet material 340 are then held in this wrapped condition, for example, using hook-and-loop (e.g., Velcro®) fastener strips as shown in the embodiments of FIGS. 3A-3D and described above. The overlapping ends of the cover sheet 340 may then be welded to each other using, for example, a heat gun set at a suitable welding temperature with a suitably shaped nozzle and a roller to bond the cover material (e.g., flame retardant vinyl) together.

To prepare the cuff end 350 for the cover 340, the end portion ring 351 is installed onto the end connection 320 (e.g., spread at split portion and press fit onto the end connection) and the filler insulation 353 is wrapped onto the end connection 320 between the end portion 351 and the insulation material 330. A section of plastic sheeting is rolled over the end portion 351, filler insulation 353 and cover end portion to form the skirt portion 352, which is secured to the end portion 351, for example, using a clamping (e.g., by band/clamp 359) or crimping arrangement.

The features described herein may be used in a variety of combinations. For example, the longitudinally wrapped insulation strip arrangement of FIGS. 2A-2D may be utilized with the spiral-wrapped strip (e.g., fabric) cover of FIG. 1. As another example, a spiral wrapped aerogel composite insulation material, as shown in the above-incorporated '900 application, may be used with the weld-sealed plastic cover sheet of FIGS. 3-3D. As still another example, the spiral-wrapped strip cover of FIG. 1 may be used with the touch safe insulating cuff arrangement of FIG. 3.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A hose assembly comprising:
a flexible hose;
an end connection attached to a first end of the hose;
an insulation material wrapped onto the exterior surface of the hose;
a cover surrounding the insulation material; and
a cuff extending over and in engagement with at least a portion of the end connection and the cover.

2. The hose assembly of claim 1, wherein the insulation material has a thermal conductivity up to about 33 mW/m K at an ambient temperature of 23° C.

3.-4. (canceled)

5. The hose assembly of claim 1, wherein the insulation material comprises a plurality of strips of insulation material wrapped concentrically around the hose to provide multiple layers of insulation.

6. The hose assembly of claim 5, wherein the plurality of strips of insulation material are secured together along a first longitudinal end.

7. The hose assembly of claim 6, wherein the plurality of strips of insulation material are secured together along the first longitudinal end such that first longitudinal ends of each of the plurality of strips are incrementally spaced, such that each of the plurality of strips forms seams that are incrementally spaced around a circumference of the hose.

8.-10. (canceled)

11. The hose assembly of claim 1, wherein the cover comprises a spiral wrapped fabric.

12. (canceled)

13. The hose assembly of claim 1, wherein the cover comprises a polymeric tube.

14. The hose assembly of claim 13, wherein the polymeric tube is heat shrunk on the insulation material.

15. The hose assembly of claim 1, wherein the cover comprises a polymer-coated fiberglass sleeve.

16. The hose assembly of claim 1, wherein the cover comprises a plastic sheet material.

17. (canceled)

18. The hose assembly of claim 16, wherein an outer longitudinal end of the plastic sheet is welded to an overlapped portion of the plastic sheet to form a seamless tube closely fitting around the insulation material.

19. The hose assembly of claim 16, wherein an inner longitudinal end of the plastic sheet is sewed to an inner longitudinal end of the insulation material.

20. The hose assembly of claim 16, wherein an inner surface of an outer longitudinal portion of the plastic sheet includes a first hook-and-loop fastener strip secured to a second hook-and-loop fastener strip disposed on an outer surface of an inner longitudinal portion of the plastic sheet.

21. The hose assembly of claim 20, wherein at least one of the first and second hook-and-loop fastener strips is arranged for securing to the other of the first and second hook-and-loop fastener strips at a plurality of locations to accommodate a plurality of hose sizes.

22. (canceled)

23. The hose assembly of claim 1, wherein the cuff comprises an elastomeric material extending over and in compressive engagement with the portion of the end connection and the cover.

24. (canceled)

25. The hose assembly of claim 23, wherein the elastomeric cuff comprises a peroxide cured silicone.

26. (canceled)

27. The hose assembly of claim 1, wherein the cuff comprises an end portion affixed to the end connection, a skirt portion affixed to the end portion and extending axially to overlap the cover, and a filler insulation axially disposed between the end portion and the insulation material.

28.-30. (canceled)

31. The hose assembly of claim 1, wherein the insulation material, the cover, and the cuff each include fire resistant materials.

32. The hose assembly of claim 1, wherein the insulation material, the cover, and the cuff each include materials rated for continuous use at a temperature of at least about 90° C.

33. A method of making an insulated hose assembly, the method comprising:
providing a hose defining an internal fluid passage and an exterior surface, and an end connection attached to a first end of the hose;
wrapping an insulation material onto the exterior surface of the hose;
installing a cover around the insulation material; and
installing a cuff over and in engagement with at least a portion of the end connection and the cover.

34.-49. (canceled)
